(19) United States
(12) Patent Application Publication
(10) Pub. No.: US 2005/0047770 A1
(43) Pub. Date: Mar. 3, 2005

(54) Imaging device and portable equipment

(76) Inventor: Toru Kuchimaru, Toyokawa-shi (JP)

Correspondence Address: Brinks Hofer Gilson & Lione, P.O. Box 10395, Chicago, IL, 60610, US

(21) Appl. No.: 10/738,490

(22) Filed: Dec. 17, 2003

(30) Foreign Application Priority Data
Aug. 29, 2003 (JP) 2003-306351

(51) Int. Cl. G02B 7/04

(52) U.S. Cl. 396/75; 250/201.2

(57) ABSTRACT

The present invention provides an imaging device that is miniature despite of having an drive unit. The imaging device has an imaging unit 2 having a photoelectric converter 8 for converting an optical image into electric signal, an optical unit 4 for forming the optical image of a subject on the photoelectric converter 8, an drive unit 5 for actuating at least part of the optical unit 4 in an optical axis direction, and a detector 6 for detecting a position of at least part of the optical unit 4 with respect to the optical axis direction. At least either of the drive unit 5 and the detector 6 are provided in a projected area A of the imaging unit 2 in the optical axis direction.

This application is based on an application No. 2003-306351 filed in Japan, the contents of which is hereby incorporated by reference.

### BACKGROUND OF THE INVENTION

The present invention relates to an imaging device installed in portable equipment such as mobile phone, PHS (Personal Handy-phone System), PDA (Personal Digital Assistant), and mobile personal computer, surveillance camera, and the like. The present invention also relates to a portable equipment utilizing the imaging device.

In recent years, mobile phones and the like having a camera installed therein have become pervasive. There has been a trend for imagers to have greater number of pixels in cameras installed in mobile phones, three hundred and ten thousand pixels has been common nowadays, and one million pixels has become commercially practical. As imaging units that include such imagers with high pixel densities, those with sizes not larger than 10 mm in length of one side (in rectangular shapes) have been developed. On the other hand, lenses of such cameras have been miniaturized so as to have sizes the same as or smaller than the imaging units have.

In the Japanese Patent Laid-Open Publication 2002-139662 has been proposed a miniature imaging device that is composed of an imaging unit and a lens part and that is suitable for mobile phone. In the imaging device, degrees of freedom of aberration correction are increased by use of two lenses in the lens part. Besides, a necessity for focusing adjustment for the two lenses is eliminated by positioning, with respect to the imaging unit, of a square-pipe-like first supporting member with which a first lens has been formed integrally and by positioning, with respect to the first supporting member, of a second supporting member in which a second lens has been installed.

Imagers with high pixel densities, however, require focusing and thus require a drive unit for moving the lenses in a direction of an optical axis for the focusing. Provision of such a drive unit involves a large camera unit and makes it difficult to install the unit in mobile phones and the like. In an extremely miniature imaging device having an imaging unit with a size not larger than 10 mm in length of one side, particularly, the provision of such a drive unit exerts a great influence upon a size of the imaging device, especially upon a projected area thereof in the direction of the optical axis.

### SUMMARY OF THE INVENTION

The present invention has been made in consideration of the problems of the prior art and an object of the invention is to provide an imaging device that is miniature despite of having a drive unit.

In order to achieve the object, the present invention provides an imaging device comprising:
an imaging unit having a photoelectric converter for converting an optical image into electric signal;
an optical unit for forming an optical image of a subject on the photoelectric converter;
a drive unit for actuating at least part of the optical unit in an optical axis direction; and
a detector for detecting a position of at least part of the optical unit with respect to the optical axis direction,
wherein at least either of the drive unit and the detector are provided in a projected area of the imaging unit in the optical axis direction.

The present invention also provides an imaging device comprising:
an imaging unit having a photoelectric converter for converting an optical image into electric signal;
an optical unit for forming an optical image of a subject on the photoelectric converter; and
a drive unit for manually actuating at least part of the optical unit in an optical axis direction,
wherein the drive unit is provided in a projected area of the imaging unit in the optical axis direction.

In accordance with the invention, the imaging device can be miniaturized and can be mounted on a mobile phone and so on despite of having the drive unit because at least either of the drive unit and the detector are provided in the projected area of the imaging unit in the optical axis direction.

The present invention further provides a portable equipment such as a mobile phone, PHS, PDA, and mobile personal computer, surveillance camera, and the like comprising the aforementioned imaging device.

### BRIEF DESCRIPTION OF THE DRAWINGS

Further objects and advantages of the present invention will become clear from the following description taken in conjunction with the preferred embodiments thereof with reference to the accompanying drawings, in which:

FIG. 1 is an exploded perspective view of an imaging device in accordance with a first embodiment of the invention;

FIG. 2 is a front view of the imaging device of FIG. 1;

FIG. 3 is a right side view, partly in section, of the imaging device of FIG. 2;

FIG. 4 is a front view illustrating a modification of the imaging device of FIG. 2;

FIG. 5 is a front view illustrating another modification of the imaging device of FIG. 2;

FIG. 6 is a right side view, partly in section, illustrating still another modification of the imaging device of FIG. 3;

FIG. 7 is an exploded perspective view of an imaging device in accordance with a second embodiment of the invention;

FIG. 8 is a front view of the imaging device of FIG. 7;

FIG. 9 is a right side view, partly in section, of the imaging device of FIG. 8;

FIG. 10 is an exploded perspective view of an imaging device in accordance with a third embodiment of the invention;

FIG. 11 is a front view of the imaging device of FIG. 10;

FIG. 12 is a right side view, partly in section, of the imaging device of FIG. 11;

FIG. 13 is an exploded perspective view of an imaging device in accordance with a fourth embodiment of the invention;

FIG. 14 is an exploded perspective view of an imaging device in accordance with a fifth embodiment of the invention;

FIG. 15 is a side view, partly in section, of the imaging device of FIG. 14;

FIGS. 16A, 16B and 16C are a front view, right side view, partly in section, and back side view, respectively, of a mobile phone with a built-in camera having the imaging device of FIGS. 1-3; and

FIG. 17 is a functional block diagram illustrating a construction of control system of the mobile phone of FIGS. 16A, 16B and 16C.

### DETAILED DESCRIPTION OF THE PREFERRED EMBODIMENTS

Hereinbelow, embodiments of the invention will be described with reference to the accompanying drawings.

(First Embodiment)

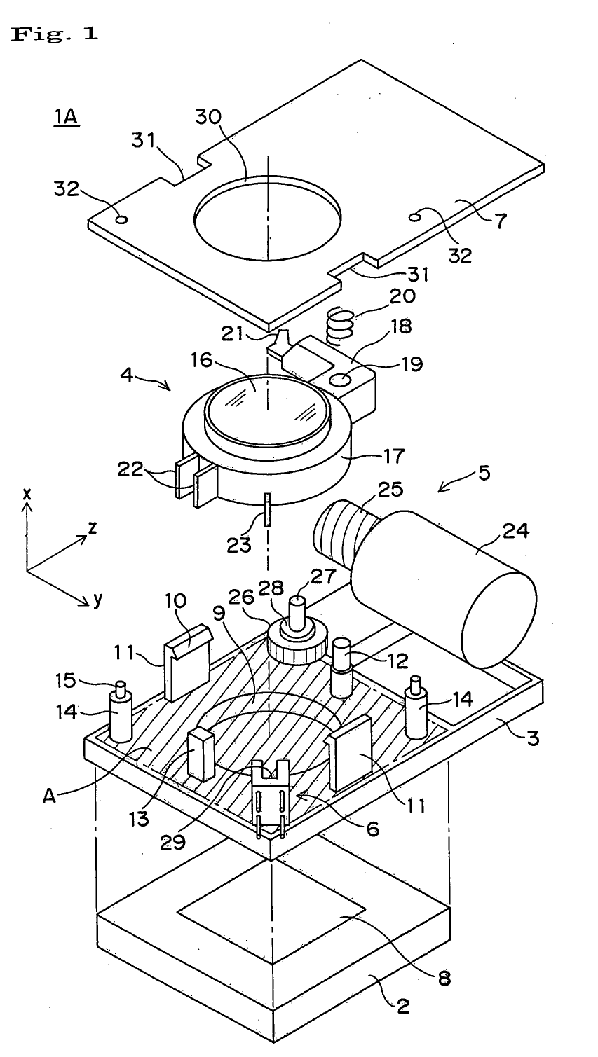

FIGS. 1 through 3 show an imaging device 1A in accordance with a first embodiment of the invention. The imaging device 1A is composed of an imaging unit 2, a chassis 3, an optical unit 4, a drive unit 5, a detector 6, and a cover 7.

The imaging unit 2 has a rectangular shape and includes a photoelectric converter 8 composed of, for example, a CCD sensor or a CMOS sensor at a center thereof. The imaging unit 2 is mounted on a control substrate not shown. Lengths of sides of the imaging unit 2 are on the order of 10 mm. The shape of the imaging unit 2 is not limited to such a rectangular one as in the embodiment but circular or other shapes may be employed.

The chassis 3 is a base on which the units of the imaging device 1A are to be mounted, and has a rectangular shape having sides substantially as long as those of the imaging unit 2 and having the remaining sides longer than those of the imaging unit 2. On a back of the chassis 3 is mounted the imaging unit 2. An aperture 9 is formed in the chassis 3, and a central axis of the photoelectric converter 8 of the imaging unit 2 is positioned so as to extend through a center of the aperture 9 in a direction perpendicular to a surface of the chassis 3 (which direction will be referred to as optical axis direction or as x direction, hereinbelow).

A pair of elastic pieces 11 having hooks 10 at extremities thereof are arranged along a direction extending through the center of the aperture 9 in parallel with the shorter sides of the chassis 3 (which direction will be referred to as y direction, hereinbelow) and protrude on both sides of the aperture 9. A cylindrical hanger shaft 12 and a rectangular-prism-like guide 13 are arranged along a direction extending through the center of the aperture 9 in parallel with the longer sides of the chassis 3 (which direction will be referred to as z direction, hereinbelow) and protrude on both sides of the aperture 9. A pair of pillars 14 that support a cover 7 are provided so as to protrude on corners on one diagonal line extending through the center of the aperture 9. A pin 15 protrudes from an extremity of each pillar 14. A cam gear 26 of the drive unit 5 and the detector 6, which will be described later, are mounted on corners on the other diagonal line extending through the center of the aperture 9.

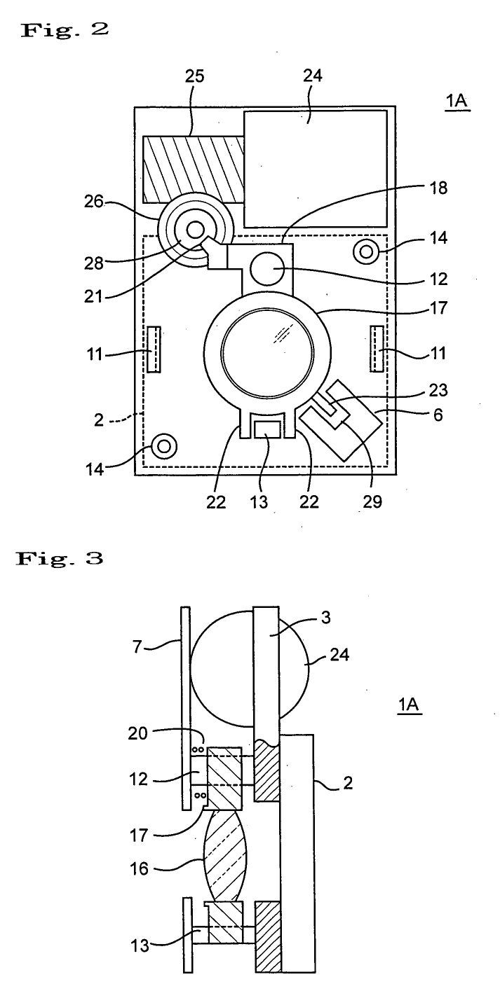

The pair of elastic pieces 11, the hanger shaft 12, the guide 13, the pair of pillars 14, and the detector 6 on the chassis 3 are provided in a projected area A of the imaging unit 2 in the optical axis direction which area is diagonally shaded in FIG. 1. Similarly, part (half, in the embodiment) of the cam gear 26 is provided in the projected area A of the imaging unit 2 in the optical axis direction. A length in y direction of the drive unit 5 including a motor 24 and a worm gear 25 is substantially the same as a width in y direction of the imaging unit 2, as shown in FIG. 2, and a thickness in the optical axis direction of the drive unit 5 including the motor 24 is substantially the same as an overall thickness in the optical axis direction of the imaging device 1A, as shown in FIG. 3.

The optical unit 4 is composed of a lens frame 17 that supports a lens 16. A protrusion 18 bent to an angle of 90° is integrally provided on a z-direction end of an outer circumferential surface of the lens frame 17, and a hanger shaft hole 19 is formed in the protrusion 18 so as to extend in parallel with the optical axis. The lens frame 17 is biased by a spring 20 in a direction nearing the imaging unit 2, with the hanger shaft 12 on the chassis 3 fit in the hanger shaft hole 19 and capable of sliding in the optical axis direction. A projection-like cam follower 21 is formed at an extremity of the protrusion 18. A pair of guide pieces 22 between which the guide 13 on the chassis 3 is fitted are provided on the outer circumferential surface of the lens frame 17 on a side opposite to the protrusion 18. Furthermore, a piece 23 that is to be detected by the detector 6 on the chassis 3 is provided on the outer circumferential surface of the lens frame 17.

The drive unit 5 is composed of the motor 24, the worm gear 25 as a driving gear fixed to a drive shaft of the motor 24, and the cam gear 26. The motor 24 is mounted on the chassis 3 so that the drive shaft of the motor parallels the chassis 3. The cam gear 26 is mounted on the chassis 3 so that the cam gear 26 meshes with the worm gear 25 and so that a shaft 27 of the cam gear 26 is made perpendicular to the drive shaft of the motor 24. The cam gear 26 has a cam surface 28 inclined with respect to the shaft 27. The cam follower 21 of the lens frame 17 is in slidable pressure contact with the cam surface 28.

The detector 6 has a slot 29 that faces the lens frame 17 and that parallels the optical axis, and light emitting elements and light receiving elements that are not shown are provided on opposed walls of the slot 29. The piece 23 to be detected on the lens frame 17 is fitted into the slot 29 of the detector 6. When the lens frame 17 moves in the optical axis direction, light from the light emitting elements is intercepted by the piece 23 to be detected, at substantially midpoint of a moving range of the frame, and a position of the lens frame 17 with respect to the optical axis direction is thereby detected.

The cover 7 covers a front of the chassis 3, and has a rectangular shape substantially the same as the chassis 3 has. The cover 7 has an aperture 30 that faces the lens frame 17. On both sides of the aperture 30 are formed cutouts 31 in which the hooks 10 of the pair of elastic pieces 11 on the chassis 3 are to be engaged. On a diagonal line extending through a center of the aperture 30 are formed pin holes 32 into which the pins 15 at the extremities of the pillars 14 on the chassis 3 are to be fitted. After the pins 15 at the extremities of the pillars 14 on the chassis 3 are fitted into the pin holes 32, the cover 7 is fixed by welding of the pins 15.

Hereinbelow, operations of the imaging device having the above configuration will be described.

The imaging device 1A is installed in portable equipment such as mobile phone, together with a control substrate not shown, and thus functions as a camera. When the lens 16 in the lens frame 17 is directed toward a subject, light incident from the subject onto the lens 16 is imaged on the photoelectric converter 8 of the imaging unit 2. The photoelectric converter 8 converts the image of the subject into electric signal and outputs the signal on a liquid crystal display not shown. The image of the subject is thus displayed on the display. Upon a press on a shutter, the image is recorded in memory.

In the imaging device 1A, as will be described below, focusing adjustment, or focusing can be performed by movement of the optical unit 4 in the optical axis direction in accordance with a distance to the subject. Rotation of the worm gear 25 with forward operation of the motor 24 in the drive unit 5 causes rotation of the cam gear 26. The cam follower 21 of the lens frame 17 that is in press contact with the cam surface 28 of the cam gear 26 is thus pressed by the cam surface 28 and the optical unit 4 consequently moves toward the subject in the optical axis direction against a biasing force of the spring 20. In this operation, the motor 24 is stopped when the piece 23 to be detected on the lens frame 17 intercepts light traveling from the light emitting elements to the light receiving elements in the detector 6. The focusing (in macro mode) on a near subject is thereby terminated.

With reverse operation of the motor 24, subsequently, the cam follower 21 of the lens frame 17 that is in press contact with the cam surface 28 of the cam gear 26 follows the cam surface 28 and moves toward the imaging unit 2 in the optical axis direction by the biasing force of the spring 20. In this operation, the motor 24 is stopped when the piece 23 to be detected on the lens frame 17 gets out of an optical path of the light traveling from the light emitting elements to the light receiving elements in the detector 6. The focusing (in standard mode) on a standard subject is thereby terminated.

Provision of multi-step cam surfaces 28 and of a plurality of sensors in the detector 6 makes it possible to perform multi-valued focusing with two or more values other than standard and macro modes. In such a configuration, automatic focusing can be performed in which a change in image contrast caused by focusing is detected from picture signal from the imager. By a similar mechanism with use of an optical unit composed of a plurality of lens groups (lens frames), focusing can be performed with movement of one lens group (lens frame) or zooming can be performed with movement of a plurality of lens groups.

In the imaging device 1A, as described above, the part of the cam gear 26 of the drive unit 5, the hanger shaft 12, the guide 13, the pair of elastic pieces 11, the pair of pillars 14, and the detector 6 are all provided in the projected area A of the imaging unit 2 in the optical axis direction which area is diagonally shaded in the drawing. The imaging device 1A with this configuration is substantially as large as the imaging unit 2 and is thus miniaturized despite of having the drive unit 5. Therefore, the imaging device 1A is miniaturized as a whole with miniaturization of the imaging unit 2 because the length in y direction of the drive unit 5 is substantially the same as the width in y direction of the imaging unit 2, and because the thickness in the optical axis direction of the drive unit 5 is substantially the same as the overall thickness in the optical axis direction of the imaging device 1A.

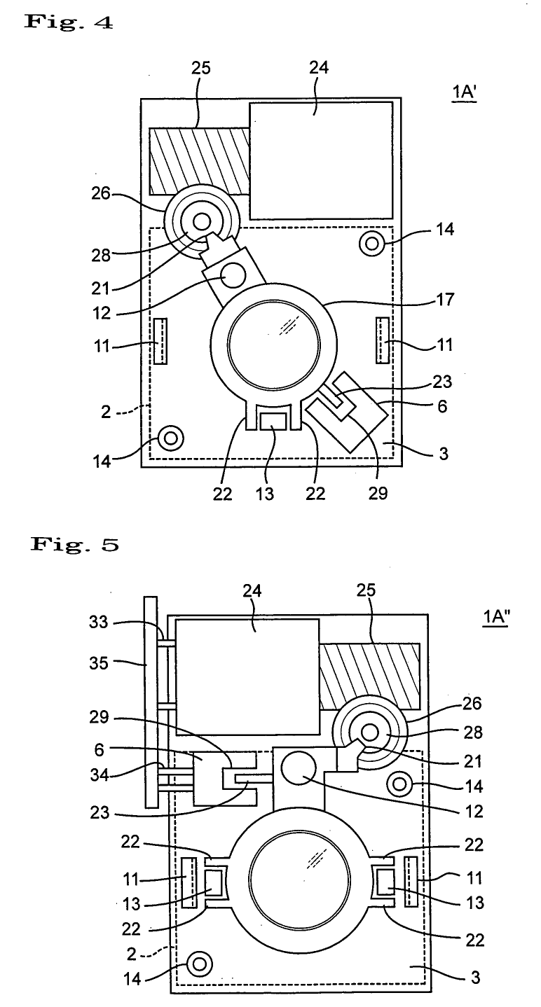

FIG. 4 shows an imaging device 1A′ in accordance with a modification of the first embodiment. In the imaging device 1A′, a hanger shaft 12 is provided on a corner of a rectangular projected area A, i.e., on a line extending between a cam gear 26 and an optical center of a lens frame 17, so that effective use is made of a wide space on the corner. A detector 6 is provided on a corner of the projected area A opposite to the hanger shaft 12 with respect to an optical axis.

FIG. 5 shows an imaging device 1A″ in accordance with another modification of the first embodiment. In the imaging device 1A″, a motor 24 is positioned in an orientation opposite to the first embodiment so that terminals 33 are positioned on left side as seen looking from a subject. Accordingly, a cam gear 26 is positioned on right side as seen looking from a subject, in contrast to the first embodiment. A detector 6 is provided so as to adjoin the motor 24 and so that terminals 34 protrude on the same side as the terminals of the motor 24. Since the terminals 33 and 34 of the motor 24 and the detector 6 have the same orientation, interconnections can easily be provided and, for example, a board 35 can directly be mounted. On both sides of a lens frame 17 are provided a pair of guides 13. A hanger shaft 12 is provided on a line that divides the imaging unit 2 into left and right halves (with respect to y direction in FIG. 5), and the detector 6 and the cam gear 26 are provided on opposite sides of the halving line.

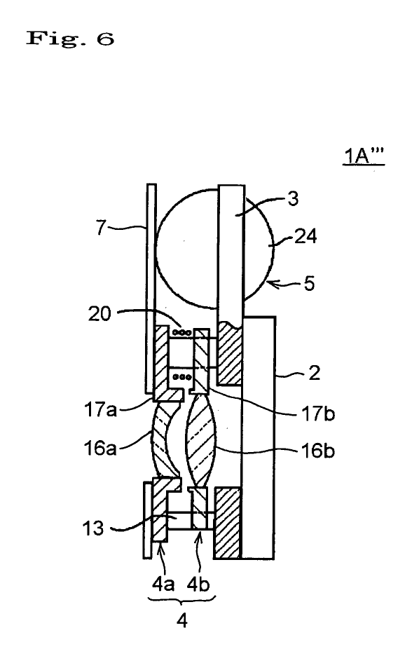

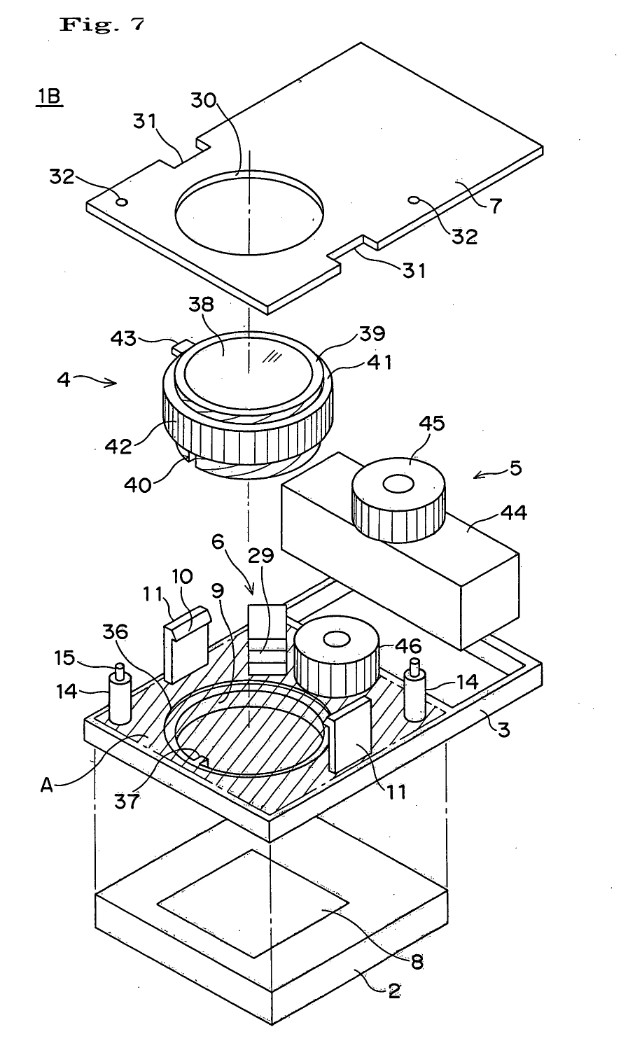

FIG. 6 shows an imaging device 1A′″ in accordance with still another modification of the first embodiment. In the imaging device 1A′″, the optical unit 4 is comprised of a front group unit 4a and a rear group unit 4b and only the rear group unit 4b among the units can be movable in the optical axis direction. That is to say, the front group unit 4a in which a concave lens 16a is supported by a lens frame 17a is fixed on the chassis 3 or the cover 7, while the rear group unit 4b in which a convex lens 16b is supported by a lens frame 17b is capable of sliding in the optical axis direction in the same manner as the optical unit 4 in the first embodiment.

In the aforementioned embodiment and the variations thereof, the worm gear 25 and the cam gear 26 are employed as a conversion mechanism for converting a rotational motion of the drive shaft into a linear motion in the optical axis direction, though any other means such as bevel gears may be used in stead of above worm mechanism. In the aforementioned embodiment and the variations thereof, if the photoelectric converter 8 of the imaging unit 8 is in a position offset from a center of the imaging unit 2 as shown in FIG. 7 which will be explained hereinafter, the hanger shaft 12, the drive unit 5 or the detector 6 may preferably be provided opposite to the offset position of the photoelectric converter 8.

For embodiments that will be described below, only differences thereof from the first embodiment will be described, and description of the substantially same parts designated by the same reference characters will be omitted.

(Second Embodiment)

FIGS. 7 through 9 show an imaging device 1B in accordance with a second embodiment of the invention. In the second embodiment, a photoelectric converter 8 of an imaging unit 2 is of CMOS type, includes an A/D converter, a timing generator, a signal processing circuit, and the like, and therefore is in a position offset from a center of the imaging unit 2.

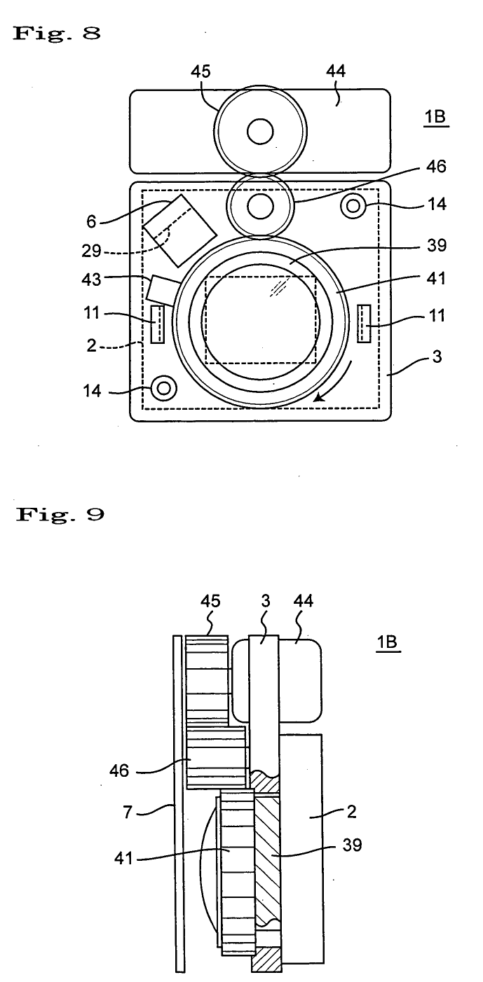

In a chassis 3, an aperture 9 is offset in conformity with the photoelectric converter 8. An annular step 36 is formed around the aperture 9, and a guide protrusion 37 is formed on a rim of the aperture 9. On the chassis 3, as is the case with the first embodiment, a pair of elastic pieces 11 and a pair of pillars 14 are formed and a detector 6 and an intermediate gear 46 are mounted. The pair of elastic pieces 11, the pair of pillars 14, the detector 6, and the intermediate gear 46 are all provided in a projected area A of the imaging unit 2 in an optical axis direction which area is diagonally shaded in FIG. 7. A length in y direction of an drive unit 5 including a motor 44 and a driving gear 45 is substantially the same as a width in y direction of the imaging unit 2, as shown in FIG. 8, and a thickness in the optical axis direction of the drive unit 5 is substantially the same as an overall thickness in the optical axis direction of the imaging device 1B, as shown in FIG. 9.

An optical unit 4 is composed of an inner barrel 39 holding a lens 38 and of an outer barrel 40 joined to outside of the inner barrel 39 with helicoid screws. A longitudinal slit 40 is formed on the inner barrel 39. The guide protrusion 37 on the chassis 3 is fitted into the slit 40, so that the inner barrel 39 is restrained from turning about the optical axis but is capable of moving in the optical axis direction. The outer barrel 41 is supported on the annular step 36 of the chassis 3, so that the outer barrel 41 is restrained from moving in the optical axis direction but is capable of turning about the optical axis. A gear 42 is formed on an outer circumference of the outer barrel 41. A piece 43 that is to be detected by the detector 6 is provided so as to protrude on part of the outer barrel 41.

The drive unit 5 is composed of a stepping motor 44 having magnets on both sides thereof, a driving gear (e.g., pinion gear) 45 mounted on a drive shaft of the motor 44, and an intermediate gear 46 that meshes with the driving gear 42 and that meshes with the gear 45 on the outer barrel 41 of the optical unit 4.

In contrast to the first embodiment, a slot 29 on the detector 6 is formed so as to extend in parallel with the chassis 3, so that the piece 43 to be detected of the optical unit 4 is fitted into the slot 29.

Hereinbelow, operations of the imaging device 1B having the above configuration will be described. Only operations different from those of the first embodiment will be described.

Rotation of the driving gear 45 with forward operation of the motor 44 of the drive unit 5 causes rotation of the intermediate gear 46 and thus causes rotation of the outer barrel 41 of the optical unit 4. The inner barrel 39 is thereby moved toward a subject in the optical axis direction. The motor 44 is stopped when the piece 43 to be detected on the outer barrel 41 intercepts light traveling from light emitting elements to light receiving elements in the detector 6. Focusing on a near subject is thereby terminated.

With subsequent reverse operation of the motor 44, the outer barrel 41 is rotated in a reverse direction through medium of the driving gear 45 and the intermediate gear 46. The inner barrel 39 is thereby moved toward the imaging unit 2 in the optical axis direction. In this operation, the motor 44 is stopped when the piece 43 to be detected on the outer barrel 41 gets out of an optical path of the light traveling from the light emitting elements to the light receiving elements in the detector 6. Focusing on a standard subject is thereby terminated.

More values than two values of standard and macro modes can be used therein, and zooming can be performed by the same mechanism with use of a zoom lens in the optical unit 4.

In the imaging device 1B, as described above, the intermediate gear 46 of the drive unit 5, the pair of elastic pieces 11, the pair of pillars 14, and the detector 6 are all provided in the projected area A of the imaging unit 2 in the optical axis direction which area is diagonally shaded in FIG. 7. Also, there is a wide space on a side opposite to the offset position of the photoelectric converter 8, and therefore effective use can be made of the wide space as a space in which the drive unit or the detector is provided. The imaging device 1B with this configuration is substantially as large as the imaging unit 2 and is thus miniaturized despite of having the drive unit 5. Therefore, the imaging device 1B is miniaturized as a whole with miniaturization of the imaging unit 2 because the length in y direction of the drive unit 5 is substantially the same as the width in y direction of the imaging unit 2, and because the thickness in the optical axis direction of the drive unit 5 is substantially the same as the overall thickness in the optical axis direction of the imaging device 1B.

(Third Embodiment)

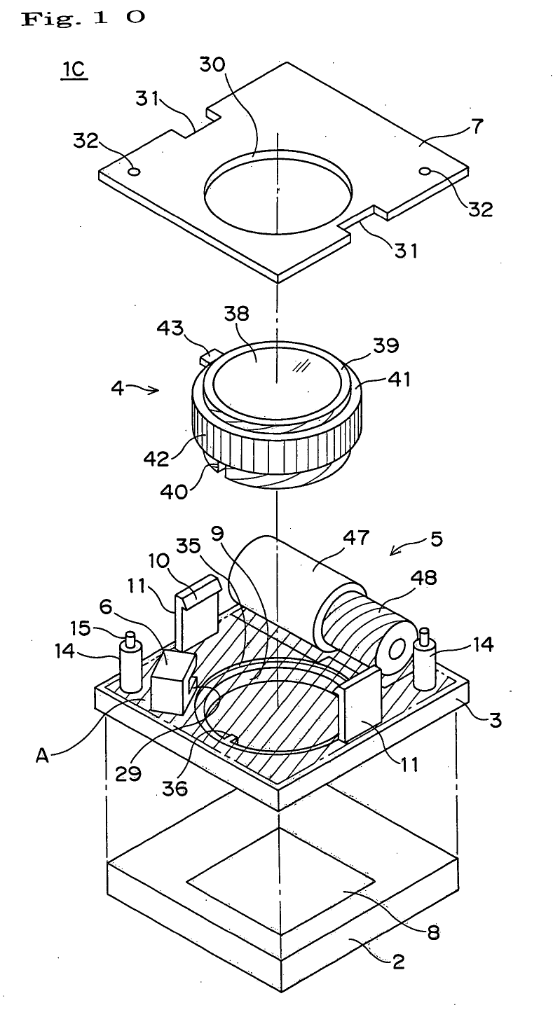

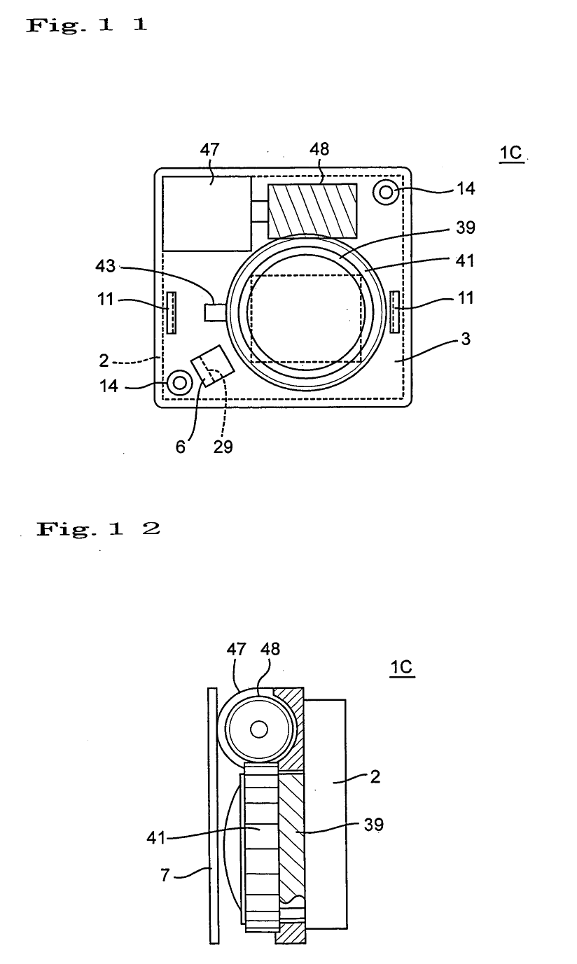

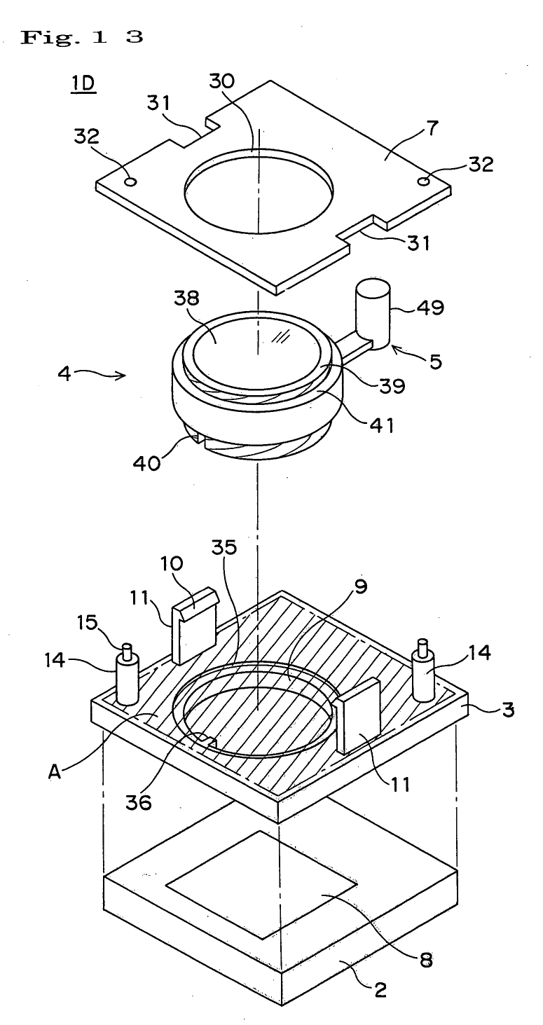

FIGS. 10 through 12 show an imaging device 1C in accordance with a third embodiment of the invention. In the third embodiment is used a helicoid-type optical unit 4, as is the case with the second embodiment. A photoelectric converter 8 on an imaging unit 2 is offset to lower right as seen looking from a subject. A chassis 3 has a rectangular shape substantially the same as an imaging unit 2, and an aperture 9 is offset in conformity with the photoelectric converter 8. An drive unit 5 is composed of a microminiature motor 47 and a worm gear 48 as a driving gear mounted on a drive shaft of the motor 47. The worm gear 48 meshes with a gear 42 on an outer barrel 41 of the optical unit 4. The drive unit 5 is provided in a space on the chassis 3 emptied by the offset of the aperture 9, that is, on upper left as seen looking from the subject.

Operations of the third embodiment are the same as those of the second embodiment, and description on the operations is omitted.

(Fourth Embodiment)

FIG. 13 shows an imaging device 1D in accordance with a fourth embodiment of the invention. In the fourth embodiment, a manual drive unit 5 is provided in place of the drive unit 5 of the imaging device 1B of the second embodiment in which the motor 44 is used. That is, the manual drive unit 5 is composed of an actuating lever 49 mounted on an outer barrel 41 of an optical unit 4. The actuating lever 49 can be manipulated by a user from exterior of the portable phone or the like. The actuating lever 49 is also provided in a projected area A of an imaging unit 2 in an optical axis direction which area is diagonally shaded in FIG. 13. Such a gear as that in the second embodiment is not formed on an outer circumference of the outer barrel 41 of the optical unit 4.

In the fourth embodiment, the actuating lever 49 may be mounted on an inner barrel 39. In this configuration, the inner barrel 39 has to be supported so as to be capable of rotating about the optical axis and capable of moving in the optical axis direction, while the outer barrel 41 has to be fixed to a chassis 3.

Also in the fourth embodiment, more values than two values of standard and macro modes can be used, and zooming can be performed by the same mechanism with use of a zoom lens in the optical unit 4.

(Fifth Embodiment)

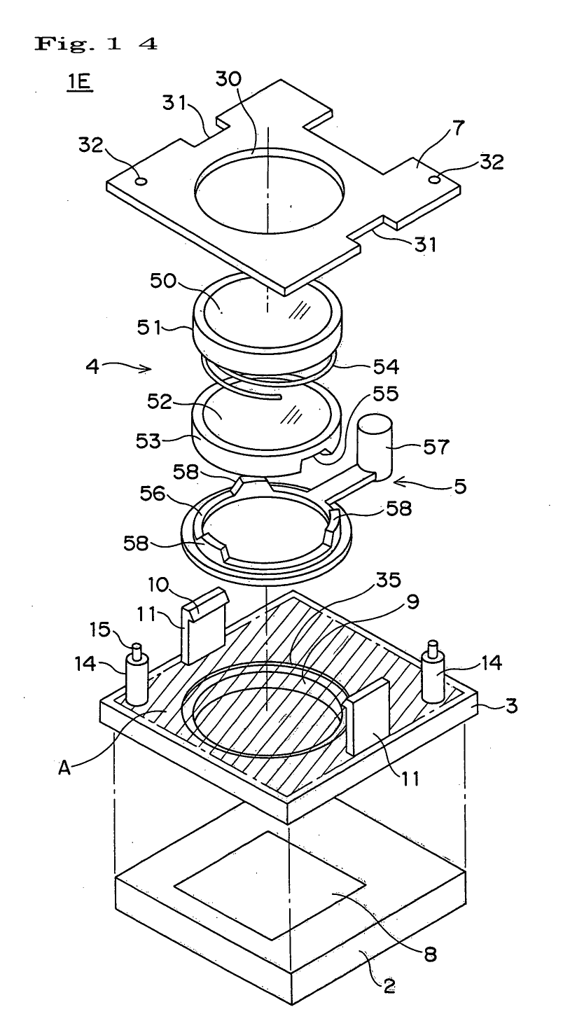

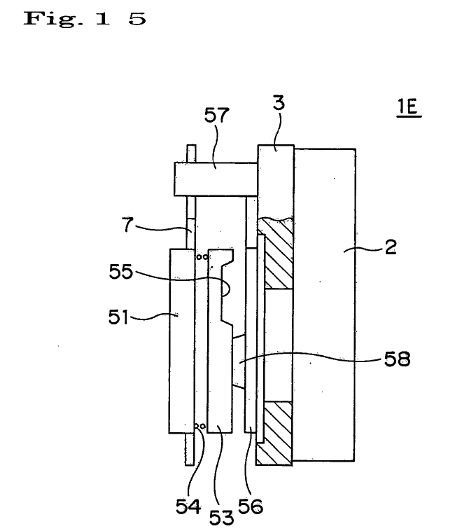

FIGS. 14 and 15 show an imaging device 1E in accordance with a fifth embodiment of the invention. The fifth embodiment includes a manual drive unit 5 as is the case with the fourth embodiment.

An optical unit 4 of the fifth embodiment is composed of a first lens frame 51 that holds a cover glass 50 and a second lens frame 53 that holds a lens 52. The first lens frame 51 is fixed to a chassis 3 by supporting means not shown. The second lens frame 53 is supported on the chassis 3 by supporting means not shown so as not to be capable of rotating about an optical axis and so as to be capable of moving in an optical axis direction. The second lens frame 53 is biased toward an imaging unit 2 by a spring 54 interposed between the first lens frame 51 and the second lens frame 53. Cam grooves 55 having substantially trapezoidal shapes are formed at three equally divided intervals on a rim of the second lens frame 53 on a side of the imaging unit 2.

The drive unit 5 is composed of a ring 56 and an actuating lever 57 that is provided integrally with an outer circumference of the ring 56 so as to extend therefrom. Cam pieces 58 having substantially trapezoidal shapes that coincide with the cam grooves 55 of the second lens frame 53 are formed at three equally divided intervals on the ring 56. The actuating lever 57 is also provided in a projected area A of the imaging unit 2 in the optical axis direction which area is diagonally shaded in the drawing.

While the cam pieces 58 of the drive unit 5 are disengaged from the cam grooves 55 of the second lens frame 53 in the fifth embodiment, as shown in FIG. 15, the second lens frame 53 is moving toward a subject against a biasing force of the spring 54 and the optical unit 4 is focused on a macro subject. When the cam pieces 58 are brought to a position on the cam grooves 55 of the second lens frame 53 by a turn of the actuating lever 57 by a predetermined angle about the optical axis, the second lens frame 53 is moved toward the imaging unit 2 in the optical axis direction by the biasing force of the spring 54 and the cam pieces 58 fit in the cam grooves 55. Thus the optical unit 4 is focused on a standard subject.

In the fifth embodiment, provision of multiple steps on the cam grooves 55 and on the cam pieces 58 allows use of more values than two values of standard and macro modes.

(Embodiment of Mobile Phone)

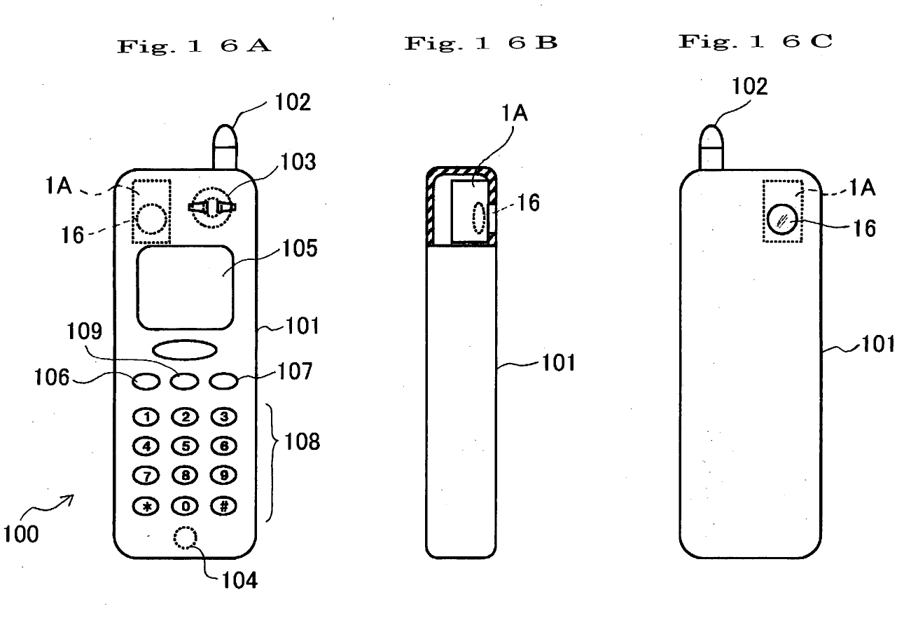

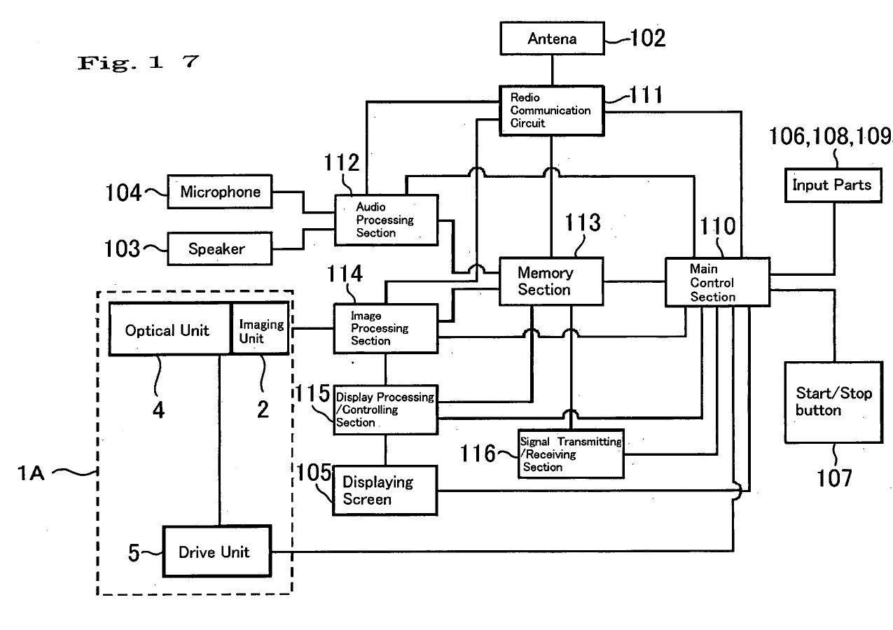

FIGS. 16A, 16B and 16C are a front view, right side view, partly in section, and back side view, respectively, of a mobile phone with a built-in camera 100. The mobile phone with a built-in camera 100 has a same construction as a typical mobile phone. The mobile phone 100 has a case 101 having a shape of long plate and a antenna 102. In the upper portion of the front surface of the case 101 is provided a speaker 103, while in the lower portion of the front surface is provided a microphone 104. On the front surface of the case 101 are disposed a display screen 105 employing, for example, liquid crystal, a calling button 106 used for transmission operation, a start/stop button 107 used for operation of power on/off, termination of call and so on, and dial operating buttons 108 used for input of telephone number and so on.

In the mobile phone 100, the imaging device 1A of the aforementioned first embodiment is provided so that the lens 16 is exposed on the back surface of the case 101. The lens 16 of the imaging device 1A can be moved so that focuses can be adjusted with respect to far and near subjects, whereby the mobile phone 100 has two photography modes, i.e., a normal mode for far distance (normal distance) photography and a macro mode for near distance photography. Operation of a photography mode selector button 109 allows the photography modes to be selected to change focusing condition. In stead of the imaging device 1A, any of the imaging devices 1A′, 1A″, A′″ and 1B-1E of the other aforementioned embodiments can be used.

FIG. 17 is a functional block diagram illustrating a construction of control system of the mobile phone 100. The mobile phone 100 has a main control section 110 for controlling the overall control system. To the main control section 110 are connected a radio communication circuit 111, an audio processing section 112, a memory section 113, an image processing section 114, a display processing/controlling section 115, a signal transmitting/receiving section 116, the displaying screen 105, the drive unit 5, input parts 106, 108 and 109, and a start/stop button 107. The radio communication circuit 111 is connected to the antenna 102, the audio processing section 112 and the memory section 113. To the audio processing section 112 are connected the microphone 104 and the speaker 103. To the memory section 113 are connected the signal transmitting/receiving section 116 and the display processing/controlling section 115. To the image processing section 114 is connected the imaging unit 2 of the imaging device 1A. The display processing/controlling section 115 is connected to the image processing section 114 and the displaying screen 105.

A signal received by the antenna 102 is demodulated at the radio communication circuit 111. An audio data is transmitted to the audio processing section 112 and an image data is transmitted to the image processing section 114. The main control section 110 allows the audio data and the image data to be outputted to the memory section 113 and stored if necessary. The audio processing section 112 processes the audio data to generate a audio signal and output it to the speaker 104. The image processing section 114 decompresses the image data to send it to the display processing/controlling section 115. The display processing/controlling section 115 adds a necessary image signal or character signal to the received image via a command from the main control section 110 and displays the received image on the displaying screen 105.

An audio signal inputted from the microphone 104 is processed at the audio processing section 112 and sent to the radio communication circuit 111. The radio communication circuit 111 modulates the audio signal to transmit it through the antenna 102.

An image data made at the imaging device 1A is sent to the image processing section 114. The image processing section 114 compresses the image data to send it both to the memory section 113 and the radio communication circuit 111. The radio communication circuit 111 modulates the image signal to transmit it through the antenna 102. The image processing section 114 sends the image date before compressed to the display processing/controlling section 115 which in turn gives the image data a necessary process to output it on the displaying screen 105 so that the image data can be monitored.

The data stored in the memory section 113, if necessary, can be processed to output through the speaker 103, display on displaying screen 105 or transmit through the antenna 102.

In order to change the focusing condition, operation of the photography mode selector button 109 allows the main control section 110 to send control signal to the drive unit 5 to move the optical unit 4 in accordance with the selected photography mode.

Although the present invention has been fully described by way of the examples with reference to the accompanying drawing, it is to be noted that various changes and modifications will be apparent to those skilled in the art. Therefore, unless such changes and modifications otherwise depart from the spirit and scope of the present invention, they should be construed as being included therein.

1. An imaging device comprising:
an imaging unit having a photoelectric converter for converting an optical image into electric signal;
an optical unit for forming an optical image of a subject on the photoelectric converter;
a drive unit for actuating at least part of the optical unit in an optical axis direction; and a detector for detecting a position of at least part of the optical unit with respect to the optical axis direction,
wherein at least either of the drive unit and the detector are provided in a projected area of the imaging unit in the optical axis direction.

2. An imaging device as claimed in claim 1, wherein the optical unit is provided in the projected area of the imaging unit in the optical axis direction.

3. An imaging device as claimed in claim 1, wherein the imaging unit has a rectangular shape, and
wherein at least either of the drive unit and the detector are provided on corners of the rectangular shape.

4. An imaging device as claimed in claim 1, wherein the photoelectric converter of the imaging unit is positioned so as to be offset from a center of the imaging unit, and
wherein at least either of the drive unit and the detector are provided opposite to the offset position of the photoelectric converter.

5. An imaging device as claimed in claim 1, wherein the optical unit comprises:
a lens; and
a lens frame which supports the lens; and
wherein the imaging device further comprises:
a chassis having a hanger shaft by which the lens frame is supported so as to be capable of moving in the optical axis direction.

6. An imaging device as claimed in claim 5, wherein the hanger shaft is provided in the projected area of the imaging unit in the optical axis direction.

7. An imaging device as claimed in claim 5, wherein the imaging unit has a rectangular shape, and
wherein the hanger shaft is provided on a corner of the rectangular shape.

8. An imaging device as claimed in claim 7, wherein the detector is provided on a corner of the imaging unit opposite to the hanger shaft with respect to the optical axis.

9. An imaging device as claimed in claim 5, wherein the photoelectric converter of the imaging unit is positioned so as to be offset from a center of the imaging unit, and
wherein the hanger shaft is provided opposite to the offset position of the photoelectric converter.

10. An imaging device as claimed in claim 5, wherein the drive unit comprises:
a motor having a drive shaft perpendicular to the optical axis of the optical unit; and
a conversion mechanism for converting a rotational motion of the drive shaft into a linear motion in the optical axis direction.

11. An imaging device as claimed in claim 10, wherein the conversion mechanism comprises:
a driving gear provided on the drive shaft of the motor; and
a cam gear meshing with the driving gear, having a cam surface with which a cam follower formed on an extension of the optical unit is in pressure contact, and having a shaft parallel to the optical axis of the optical unit, and
wherein at least part of the cam gear is provided in the projected area of the imaging unit in the optical axis direction.

12. An imaging device as claimed in claim 5, wherein the imaging unit has a rectangular shape, and
wherein the chassis has a substantially oblong shape, one side of which has a substantially same length as that of the imaging unit.

13. An imaging device as claimed in claim 12, wherein the imaging device further comprises a cover which covers the front face of the imaging device and has an aperture for directing light from the subject to the optical unit, and
wherein the chassis comprises a pair of elastic pieces having hooks at extremities thereof, and
wherein the hooks of the pair of elastic pieces engage with the cover so that the cover is fixed on the chassis.

14. An imaging device as claimed in claim 1, wherein the optical unit comprises:
a lens;
an inner barrel holding the lens; and
an outer barrel meshing with outside of the inner barrel through medium of helicoid screws.

15. An imaging device as claimed in claim 14, wherein the drive unit comprises:
a motor having a drive shaft parallel to the optical axis of the optical unit;
a driving gear provided on the drive shaft of the motor; and
an intermediate gear that meshes with the driving gear and that meshes with a gear formed on an outer circumferential surface of the outer barrel of the optical unit, and
wherein at least part of the intermediate gear is provided in the projected area of the imaging unit in the optical axis direction.

16. An imaging device as claimed in claim 14, wherein the drive unit comprises:
a motor having a drive shaft perpendicular to the optical axis of the optical unit; and
a driving gear that is provided on the drive shaft of the motor and that meshes with a gear formed on an outer circumferential surface of the outer barrel of the optical unit, and
wherein at least either of the motor and the driving gear are provided in the projected area of the imaging unit in the optical axis direction.

17. An imaging device as claimed in claim 1, wherein the detector is provided so as to adjoin the drive unit, and
wherein output terminals of the detector and feeder terminals of the drive unit protrude in the same direction.

18. An imaging device as claimed in claim 1, wherein the hanger shaft is positioned on a bisector line that bisects the imaging unit up and down or left and right, and
wherein the drive unit and the detector are positioned on opposite sides with respect to the bisector line.

19. An imaging device comprising:
an imaging unit having a photoelectric converter for converting an optical image into electric signal;
an optical unit for forming an optical image of a subject on the photoelectric converter; and
an drive unit for manually actuating at least part of the optical unit in an optical axis direction,
wherein the drive unit is provided in a projected area of the imaging unit in the optical axis direction.

20. An imaging device as claimed in claim 19, wherein the optical unit comprises:
a lens;
an inner barrel holding the lens; and
an outer barrel that meshes with outside of the inner barrel through medium of helicoid screws,
wherein the drive unit comprises an actuating lever extending from the outer barrel or the inner barrel, and
wherein the actuating lever is provided in the projected area of the imaging unit in the optical axis direction.

21. An imaging device as claimed in claim 19, wherein the optical unit comprises:
a lens;
a lens frame that holds the lens and that is supported so as to be capable of moving in the optical axis direction, and
wherein the drive unit comprises:
a spring for biasing the lens frame in the optical axis direction;
a ring having cam pieces that coincide with cam grooves formed on the lens frame, the ring capable of rotating about the optical axis; and
an actuating lever extending from the ring, and
wherein the actuating lever is provided in the projected area of the imaging unit in the optical axis direction.

22. A portable equipment comprising the imaging device as claimed in claim 1.

23. A portable equipment as claimed in claim 22, wherein the optical unit comprises:
a lens; and
a lens frame which supports the lens, and
wherein the imaging device further comprises:
a chassis having a hanger shaft by which the lens frame is supported so as to be capable of moving in the optical axis direction, and
wherein the hanger shaft is provided on a corner of the rectangular shape.
